(19) United States
(12) Patent Application Publication
(10) Pub. No.: US 2005/0024874 A1
(43) Pub. Date: Feb. 3, 2005

(54) Decorative bulbs

(76) Inventor: Yu-Peng Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/627,663

(22) Filed: Jul. 28, 2003

(51) Int. Cl. F21V 9/00

(52) U.S. Cl. 362/255; 362/293

(57) ABSTRACT

The present invention relates to a decorative bulb used on a lighting string. The bulb can be provided with various color areas or grain areas on the glass shell. The decorative bulb with different outlook has a special function and it can be distinguished from other bulbs very easily.

### BACKGROUND OF THE INVENTION

A decorative bulb is popular in this time and it is always designed with a standard size for common use. Although a decorative bulb having different functions for special application can be provided, the bulb has the same standard size all the time. It is difficult to distinguish the bulbs with various functions. When a light string is to be assembled with different bulbs to display special lighting effect, it is very trouble to distinguish the bulbs. If there is any mistake, the light string cannot work normally.

Accordingly, the present invention is to provide a structure for the decorative bulb, which can be provided with different color or grain. So the bulb having various color or grain can be recognized in ease.

### BRIEF DESCRIPTION OF THE DRAWINGS

The following drawings indicate the character and improvement of the present invention.

FIG. 1 is a perspective view of a decorative bulb according to the present invention.

FIG. 2 is a perspective view of another embodiment of the decorative bulb according to the present invention.

FIG. 3 is a perspective view of a further embodiment of the decorative bulb according to the present invention.

### DETAILED DESCRIPTION OF THE INVENTION

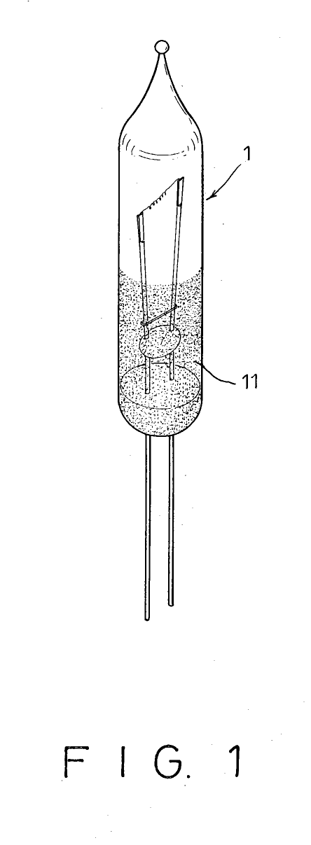

Referring firstly to FIG. 1, the present invention relates to a decorative bulb (1) used in a lighting string. A conventional bulb has a simply transparent glass shell. The characteristic of the present invention is to provide a color area (11) of the bulb (1). Hence, the bulb (1) is divided to two areas, a transparent area and a color area (11). It can be distinguished from a conventional bulb very easily.

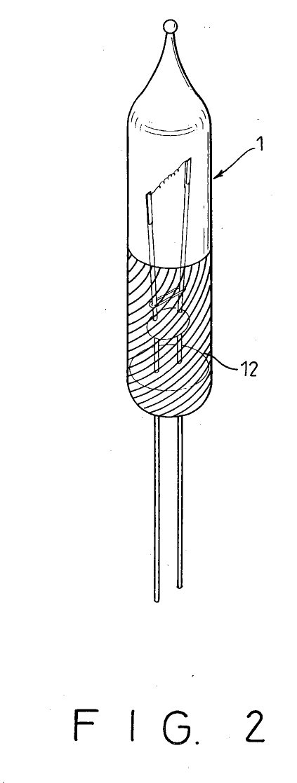

In application, as shown in FIG. 2, the decorative bulb (1) of this invention can be provided with a grain area (12) to represent another bulb having different function. And it will not be confused with other bulbs.

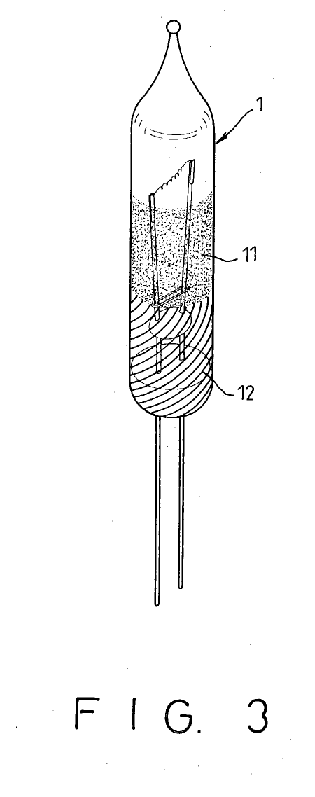

As shown in FIG. 3, the decorative bulb of the present invention can also be designed with three various areas, a transparent area, a color area (11), and a grain area (12). The decorative bulb having three areas on the glass shell is to be a different bulb with different function and can be recognized easily. Accordingly, the present invention obtains utility for use and should be allowed for patent.

1. A decorative bulb having a transparent glass shell, on which a color area or a grain area is provided.

2. A decorative bulb as claimed in claim 1, wherein the decorative bulb can be provided with a color area and a grain area of the transparent glass shell at the same time.
